(19) United States
(12) Patent Application Publication
(10) Pub. No.: US 2016/0090017 A1
(43) Pub. Date: Mar. 31, 2016

(54) BICYCLE STORAGE IN A VEHICLE

(71) Applicant: Ford Global Technologies, LLC, Dearborn, MI (US)

(72) Inventors: Sudipto Aich, Palo Alto, CA (US); David Melcher, Ypsilanti, MI (US); Zachary David Nelson, Detroit, MI (US); Christopher Peplin, Ann Arbor, MI (US); Jamel Seagraves, Mountain View, CA (US)

(73) Assignee: FORD GLOBAL TECHNOLOGIES, LLC, Dearborn, MI (US)

(21) Appl. No.: 14/500,490

(22) Filed: Sep. 29, 2014

(51) Int. Cl. B60P 1/48; H01R 25/00; B60R 9/10

(52) U.S. Cl. CPC B60P 1/48; B60R 9/10; H01R 25/006

(57) ABSTRACT

A bicycle stowage mechanism is configured to be mounted on a vehicle. At least one first connector is included in the stowage mechanism and is configured to be communicatively coupled to a computer wherein the at least one first connector is mateable to a respective at least one second connector that is associated with a bicycle. The memory of the computer stores instructions to cause the processor to receive an indication that the at least one first connector is mated to at least one second connector associated with a bicycle and, upon receiving the indication, initiate a bicycle stowage operation.

### BACKGROUND

Bicycles, particularly so-called eBikes, i.e., bicycles that include electric motors that supplement or replace pedaling, can be heavy and unwieldy. Therefore, an eBike can be difficult for a person to lift and handle, e.g., when stowing the eBike for transport in a motor vehicle. Further, although mechanisms exist for stowing an eBike in a vehicle for transport, it can be difficult and time-consuming to ensure that the eBike is properly stowed and that the vehicle is ready to transport the eBike.

### DRAWINGS

FIG. 1 is a block diagram of a system for automated bicycle stowage.

FIG. 2 is a perspective view of a portion of the system of FIG. 1, including a bicycle in an un-stowed configuration.

FIG. 3 is a perspective view of a portion of the system of FIG. 1, including a bicycle in a pre-stowed configuration.

FIG. 4 is a process flow diagram illustrating an exemplary process for stowing an eBike in a vehicle.

### DESCRIPTION

### Introduction

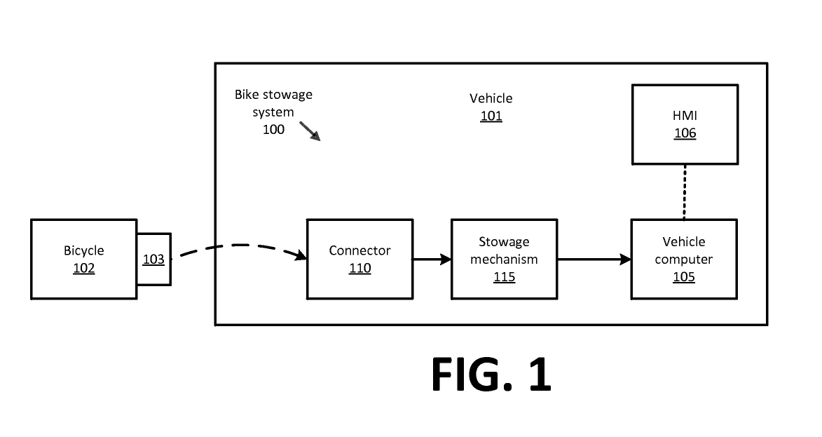

FIG. 1 is a block diagram of a bicycle stowage system 100 provided in a motor vehicle, e.g., an automobile, 101. A vehicle computer 105 monitors and/or controls a stowage mechanism 115, including a vehicle connector 110 that mates with a bicycle 102 connector 103. The computer 105 is communicatively coupled to the connector 110 and/or to actuators, controllers, etc. of the stowage mechanism 115. When a connection is detected between the connectors 103, 110, the computer 105 may be programmed to actuate a stowage operation whereby the bicycle 102 is stowed on or in the vehicle 101. Further, the computer 105 may be programmed to determine that a stowage operation is complete, and to then permit movement of the vehicle 101.

### System Overview

A vehicle 101, as mentioned above, is a motor vehicle such as an automobile. A bicycle 102 stored in or on the vehicle 101 may be an eBike (i.e., including an electric motor that supplements or replaces pedaling), a folding or portable bicycle, or other bicycle suitable for use with a stowage mechanism 115, which may be any one of a variety of bicycle stowage and/or carrying devices such as are known for use with motor vehicles.

The bicycle 102 includes at least one connector 103. As mentioned above, the connector 103 is mateable to the stowage mechanism 115 connector 110. The connector 103 is provided so that the computer 105, via the connector 110, can detect that the bicycle 102 is attached to the stowage mechanism 115 in a manner such that a stowage operation may commence. Accordingly, the connector 103 can take a variety of forms, such as an electrical connector, a magnet, etc. For example, the connector 103 could include a “hard” connection to the bicycle 102 for physically manipulating, e.g., lifting and carrying to a stowed position as well as providing a wired data and/or charging connection. Alternatively or additionally, a connector 103 could be provided for wireless charging and/or data connections.

In general, the connector 103 is located on the bicycle 102 in a position to facilitate connection to the connector 110.

Further, multiple connectors 103 could be provided on a bicycle 102 for connection to multiple connectors of a stowage mechanism 115. For example, connectors 103 could be located on a foldable or collapsible bicycle 102 such that connection of the connectors 103 to respective connectors 110 would provide an indication to the computer 105 that the bicycle 102 was properly positioned for a stowage operation to commence. For example, for a stowage mechanism 115 that stores a bicycle 102 in a vehicle 101 compartment, e.g., a trunk, such placement of connectors 103, could ensure that the bicycle 102 was properly folded and/or positioned to be stowed.

The vehicle 101 computer 105 is included in the system 100 for carrying out various operations, including as described herein, and generally includes a processor and a memory, the memory including one or more forms of computer-readable media, and storing instructions executable by the processor for performing various operations, including as disclosed herein. The memory of the computer 105 further generally stores remote data received via various communications mechanisms; e.g., the computer 105 is generally configured for communications on a controller area network (CAN) bus or the like, and/or for using other wired or wireless protocols, e.g., Bluetooth, etc. The computer 105 may also have a connection to an onboard diagnostics connector (OBD-II).

Via the CAN bus, OBD-II, and/or other wired or wireless mechanisms, computer 105 may transmit messages to various devices in a vehicle and/or receive messages from the various devices, e.g., controllers, actuators, sensors, etc., e.g., controllers and sensors as discussed herein, e.g., the connector 110 and/or actuators or the like included in the stowage mechanism 115. Although one computer 105 is shown in FIG. 1 for ease of illustration, it is to be understood that the computer 105 could in fact, include, and various operations described herein could be carried out by, one or more computing devices, e.g., vehicle component controllers such as are known and/or a computing device dedicated to the system 100.

Further, the computer 105 could include a human machine interface (HMI) 106, that includes one or more known mechanisms for a user to provide input to, and receive output from, the computer 105. Such mechanisms include, without limitation, voice recognition, audio output, a touchscreen or other input device, and/or a remote computing device communicatively coupled to the computer 105, such as a smart phone or the like.

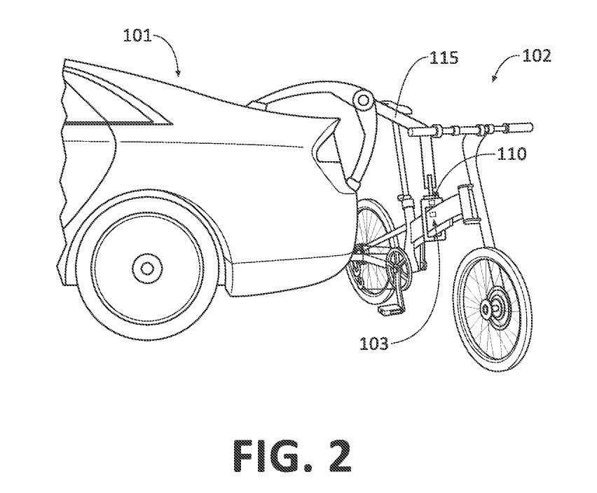

FIG. 2 is a perspective view of a portion of the system 100 of FIG. 1, including a bicycle 102 in an un-stowed or pre-stowed (e.g., partially stowed or in the process of being stowed) configuration with respect to a vehicle 101. As seen in FIG. 2, an articulated arm or the like of a stowage mechanism 115 may include the vehicle connector 110, provided to made to the bicycle connector 103. Note that the stowage mechanism 115 could include other features such as may be used in bicycle stowage and/or carrying mechanisms for vehicles. For example, the stowage mechanism 115 could include a tray or platform on which bicycle 102 wheels could be placed, multiple articulating arms, etc. Accordingly, the connector 110 could be included in a variety of different kinds of stowage mechanism 115.

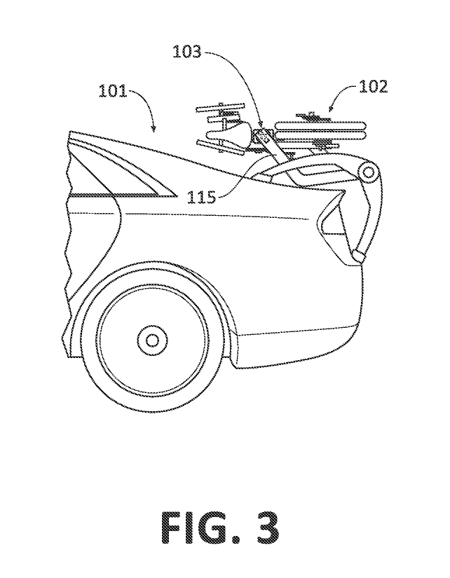

FIG. 3 is a perspective view of a portion of the system of FIG. 1, including a bicycle 102 in a stowed configuration. As seen in FIG. 3, arms of the stowage mechanism 115 may be retracted to stow the bicycle 102 on the vehicle 101 for transport. However, as mentioned above, a stowage mechanism 115 could stow the bicycle 102 in a vehicle 101 compartment such as a trunk, and/or in some other configuration with respect to the vehicle 101.

### Processing

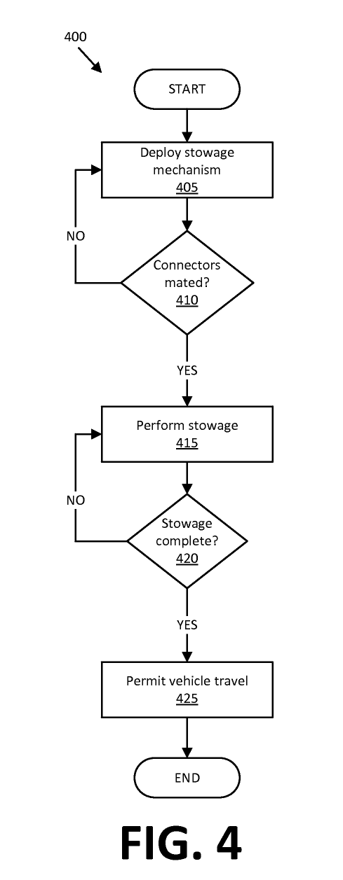

FIG. 4 is a process flow diagram illustrating an exemplary process 400 for stowing a bicycle 102 in a vehicle 101. The process 400 begins in a block 405, in which the stowage mechanism 115 is deployed. For example, as seen in FIG. 2, the stowage mechanism 115 may be positioned to facilitate connection of the connectors 103, 110 and securing of the bicycle 102 to the stowage mechanism 115. Deployment of the stowage mechanism 115 may be initiated in a variety of ways. For example, the mechanism 115 could be manually unfolded, extended, etc. from the vehicle 101. Alternatively or additionally, a user could provide input to the computer 105, e.g., via an HMI 106, a smartphone or the like in communication with the computer 105, a button or other user input mechanism in the vehicle 101, etc., to instruct the computer 105 to initiate deployment of the stowage mechanism 115.

Next, in a block 410, the computer 105 determines whether the connectors 103, 110 are mated to one another. As mentioned above, multiple connectors 103 could respectively be mated to connectors 110. The computer 105 determines whether the connectors 103, 110 are mated by receiving a signal from the connector 110, e.g., as a wired or wireless signal from the connector 103 indicating that it is connected to the connector 110; the connectors 103, 110 together could comprise a locking connector mechanism. For example, the connector 110 could include a sensor for detecting a magnetic or electrical connection between connectors 103, 110, and could include a processor programmed to indicate such signal to the computer 105. Further, as mentioned above, the bicycle 102 may need to be folded, collapsed, etc. and/or otherwise arranged with respect to the mechanism 115, for a connection or respective connections between connectors 103, 110 to be established and indicated to the computer 105. In any event, if all connectors 103, 110 are determined to be mated, then the process 400 proceeds to a block 415. Otherwise, the process 400 returns to the block 405.

In a block 415, stowage of the bicycle 102 on or in the vehicle 101 is performed. For example, upon detecting that all connectors 103, 110 are mated, the computer 105 may send a signal to an actuator or actuators of the mechanism 115 to commence a stowage operation. Such actuators may be coupled to electric motors or the like for moving arms and/or other parts of the mechanism 115, as well as possibly components of the vehicle 101, e.g., a trunk lid or the like. Alternatively or additionally, the computer 105 could be programmed to indicate via an HMI that a stowage operation could be commenced, and could further be programmed to receive input from a user to commence such stowage operation.

Following the block 415, in a block 420, the computer 105 determines whether the stowage operation is complete. For example, the computer 105 could be configured to detect a position of the stowage mechanism 115, closure of a vehicle 101 compartment, such as a trunk, etc. Alternatively or additionally, the computer 105 could be configured to detect a position of the connector 105 as being indicative of a stowed position. If the stowage operation is complete, then the process 400 proceeds to a block 425. Otherwise, the process 400 returns to a block 415.

In the block 425, which is optional, having confirmed that stowage of the bicycle 102 is complete, the computer 105 permits travel of the vehicle 101. For example, the computer 105 could provide an instruction to a transmission controller or engine controller of the vehicle 101 indicating that movement is permitted.

Following the block 425, the process 400 ends.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a computer that includes a processor and a memory for storing instructions executable by the processor;
a bicycle stowage mechanism configured to be mounted on a vehicle; and
at least one first connector that is included in the stowage mechanism and that is configured to be communicatively coupled to the computer wherein the at least one first connector is mateable to a respective at least one second connector that is associated with a bicycle;
further wherein the memory of the computer stores instructions to cause the processor to:
receive an indication that the at least one first connector is mated to at least one second connector associated with a bicycle and,
upon receiving the indication, initiate a bicycle stowage operation.

2. The system of claim 1, wherein the at least one first connector is a plurality of first connectors and the at least one second connector is a plurality of second connectors, further wherein each of the first connectors is arranged to be mateable to a respective one of the second connectors.

3. The system of claim 2, wherein at least one of the second connectors is mateable to a respective one of the first connectors only when the bicycle is in a folded configuration.

4. The system of claim 1, wherein the stowage mechanism includes an articulating arm.

5. The system of claim 4, wherein the at least one first connector is mounted on the articulating arm.

6. The system of claim 1, wherein the stowage mechanism includes a tray arranged to accommodate bicycle wheels.

7. The system of claim 1, wherein the computer further stores instructions to cause the processor to determine whether the stowage operation is complete.

8. The system of claim 7, wherein the computer further stores instructions to provide a signal permitting travel of the vehicle upon determining that the stowage operation is complete.

9. The system of claim 7, wherein determining that the stowage operation is complete includes at least one of determining a position of the at least one first connector and determining a position of a vehicle component.

10. The system of claim 1, wherein the bicycle is an eBike.

11. A method, comprising:
connecting at least one first connector that is included in a stowage mechanism that is mounted on a vehicle to a respective at least one second connector that is associated with a bicycle, wherein at least the at least one first connector is communicatively coupled to a vehicle computer;
receiving, in the computer, an indication that the at least one first connector is mated to at least one second connector; and
upon receiving the indication, initiating a bicycle stowage operation.

12. The method of claim 11, wherein the at least one first connector is a plurality of first connectors and the at least one second connector is a plurality of second connectors, further wherein each of the first connectors is arranged to be mateable to a respective one of the second connectors.

13. The method of claim 12, wherein at least one of the second connectors is mateable to a respective one of the first connectors only when the bicycle is in a folded configuration.

14. The method of claim 11, wherein the stowage mechanism includes an articulating arm.

15. The method of claim 14, wherein the at least one first connector is mounted on the articulating arm.

16. The method of claim 11, wherein the stowage mechanism includes a tray arranged to accommodate bicycle wheels.

17. The method of claim 11, further comprising determining whether the stowage operation is complete.

18. The method of claim 17, further comprising providing a signal permitting travel of the vehicle upon determining that the stowage operation is complete.

19. The method of claim 17, wherein determining that the stowage operation is complete includes at least one of determining a position of the at least one first connector and determining a position of a vehicle component.

20. The method of claim 11, wherein the bicycle is an eBike.
